(19) United States
(12) Patent Application Publication
(10) Pub. No.: US 2016/0364509 A1
(43) Pub. Date: Dec. 15, 2016

(54) METHOD FOR SIMULATING TEMPERATURE FIELD OF DISTRIBUTED UNDERGROUND FACILITY IN MOUNTAIN MASS

(71) Applicant: HUAZHONG UNIVERSITY OF SCIENCE AND TECHNOLOGY, Wuhan, Hubei (CN)

(72) Inventors: Tianxu ZHANG, Wuhan, Hubei (CN); Wenxuan MA, Wuhan, Hubei (CN); Longwei HAO, Wuhan, Hubei (CN); Cen LU, Wuhan, Hubei (CN); Heng YAO, Wuhan, Hubei (CN); Yuehuan WANG, Wuhan, Hubei (CN); Nong SANG, Wuhan, Hubei (CN); Weidong YANG, Wuhan, Hubei (CN)

(21) Appl. No.: 15/106,693

(22) PCT Filed: Feb. 10, 2015
(86) PCT No.: PCT/CN2015/072654

§ 371 Date: Jun. 20, 2016

(30) Foreign Application Priority Data
Dec. 30, 2014 (CN) 201410849195.7

(51) Int. Cl. G06F 17/50; G06T 17/05; G06T 17/00; G06F 17/13

(52) U.S. Cl. CPC G06F 17/5009; G06F 17/13; G06T 17/05; G06T 17/005

(57) ABSTRACT

The present invention discloses a method for stimulating a temperature field of a mountain mass containing a distributed underground facility under the influence of a seepage effect. The method comprises the following steps: establishing three-dimensional geometric models of the mountain mass and the underground facility by using contour line data extracted from elevation information, equating a seepage field with randomly and uniformly distributed “capillary tubes” of the mountain mass, abstracting mountain mass data to be a multi-way tree having a hierarchical structure, and precisely calculating the height of each “capillary tube” by using an algorithm of determining whether a point is in a closed graphic in computer graphics, thereby establishing a geometric model of an equivalent seepage field in the geometric model of the mountain mass; then, finding, through a programmed design, information about surfaces of the constructed underground facility and the “capillary tubes” by using a configuration file generated by ANSYS, and stimulating the temperature field of the mountain mass containing the distributed underground facility under the influence of the seepage field.

### TECHNICAL FIELD

The present invention relates to the interdisciplinary field of physical geography, thermophysics, and information processing, and in particular, to a method for simulating a temperature field of a distributed underground facility in a mountain mass, which is used to simulate a temperature field of a mountain mass containing a distributed underground facility under the influence of a seepage effect.

### BACKGROUND ART

The fissured rock mass is a type of complex rock mass commonly seen in rock mass engineering such as dam foundations, side slopes, and underground caverns, and is a discontinuous medium consisting of randomly distributed fissures and rocks cut by the fissures. There are fissures between rock and soil, where the fissures are filled with a flowing water medium, which is referred to as seepage.

Temperature field distribution of the mountain mass is controlled by temperature distribution and a thermal state of the shallow crust, and is also affected by rock mass engineering and external conditions (including underground water seepage). The theoretical and experimental study indicates that there are three thermodynamic transfer (i.e., heat transfer) modes: conduction, convection, and radiation. Temperature field distribution in engineering rock mass is mainly implemented by means of conduction and convection. The seepage movement of the underground water transfers heat by means of thermal convection, thus affecting the temperature field distribution of the fissured rock mass. The seepage speed of the underground water in the fissured rock mass directly controls a variation amplitude of the temperature of the rock mass. Therefore, seepage has a very significant effect on temperature.

There are various fissures and broken rocks in a fault zone, the underground water flow flows along a vertical direction in fissures, and the temperature of the underground water flow is lower than the temperature of the rock mass. Therefore, heat of the rock mass is transferred to the water flow, so that the temperature of the water flow gradually increases along the flowing direction, thus changing the temperature field distribution of the rock mass. Through the thermal convection exchange between the water flow and surrounding rocks, the temperature of the water flow is approximate to the temperature of the rock mass, and heat in a given range achieves an equilibrium state.

In an existing underground object thermal simulation method, only influence of conduction by solids such as rock and soil on the thermal field distribution of the underground facility is considered, while the influence of rock fissures and the fluid medium therein on the underground temperature field distribution is not considered; however, the fluid medium makes the thermal field exchange between the underground facility and the mountain mass quicker, and the expression on the surface more evident. Moreover, in the large-scale general finite element analysis software (ANSYS), there is no parameter for describing a seepage rate of rock fissures.

### SUMMARY

In the present invention, the fissured rock mass is considered as a material having a continuous medium property, that is, it is assumed that the fissured rock mass consists of a fissure system with poor porosity and strong transmissibility and rock with good porosity and poor transmissibility. According the double media theory, the present invention provides a method of equating a seepage field with “capillary tubes” randomly and uniformly distributed in a mountain mass, to simulate a temperature field of a mountain mass containing a distributed underground facility under the effect of the seepage field.

To implement the foregoing objective, the present invention provides a method for simulating a temperature field of a distributed underground facility in a mountain mass, where the method includes the following steps:

(1) performing simulation modeling on physical characteristics and temperature distribution of the mountain mass and the distributed underground facility: performing modeling on physical characteristics of the mountain mass and the distributed underground facility, and directly performing physical characteristic modeling on geometric structures of the mountain mass and the distributed underground facility in a Simulation Platform Of Temperature/Infrared Image Formation (SPTIF) according to the physical characteristic models, thereby establishing geometric models of the mountain mass and the distributed underground facility;

(2) seepage field modeling: abstracting a seepage field to be multiple thin tubes that are randomly and uniformly distributed in the mountain mass, and adding the tubes to a temperature simulation model of the distributed underground facility; and

(3) simulating the temperature field, with the effect of the seepage field and without the effect of the seepage field, of the mountain mass containing the distributed underground facility.

In an embodiment of the present invention, step (2) specifically includes the following sub-steps:

(2.1) abstracting a data structure of mountain mass data, and abstracting the entire mountain mass to be a mountain mass tree structure consisting of finite nodes and having a hierarchical relationship; and

(2.2) traversing the foregoing generated mountain mass tree structure by using an algorithm of determining whether a point is in a closed polygon, generating bottom surface coordinates of multiple random thin tubes, obtaining the height of each thin tube, and generating capillary tubes.

In an embodiment of the present invention, step (2.1) specifically includes:

separating contour line data of the mountain mass into 17 areas, where the areas are at the same elevation, different areas are independent of each other and do not intersect with each other in a horizontal direction, and have a hierarchical structure in a vertical direction, and a vertical-direction projection of a high-elevation area is contained in a low-elevation closed curve; and

further abstracting the mountain mass by using a data structure of a multi-way tree, where a method for constructing the mountain mass tree structure is as follows: turning the mountain mass upside down, and using each area as a node, where the bottom of the mountain is a root node of the tree, and if an upper layer and a lower layer have such a closed interval inclusion relationship that a vertical-direction projection of the upper layer contains a vertical-direction projection of the lower layer, the lower layer is a child node of the upper layer.

In an embodiment of the present invention, step (2.2) specifically includes:

randomly generating bottom surface coordinates of one “capillary tube”, and determining, starting from a node at the bottom layer of the mountain mass tree structure, whether the coordinate points are in a closed curve formed by all points at this layer, wherein if the coordinate points are in the closed curve, and if a node where this layer is located is a leaf node, a maximum height of the “capillary tube” is equal to an elevation of this node, or if the node is not a leaf node, child nodes of a lower layer are traversed; if the coordinate points are not in the closed curve, other nodes at the same elevation are traversed, and if the coordinate points are not in a closed curve formed by all nodes at this elevation, it indicates that a maximum height of the “capillary tube” is equal to an elevation of a father node of this node; and traversing all nodes in the mountain mass tree structure to find maximum elevations corresponding to all the nodes, thus determining heights corresponding to all “capillary tubes”.

In an embodiment of the present invention, the algorithm of determining whether a point is in a closed polygon in step (2.2) specifically includes:

(2.2.1) making a horizontal line from point P, and traversing, starting from point P₀ of the closed polygon, all points of the entire polygon, where a point before point P₀ is expressed as P₁, and a point after point P₀ is expressed as P₂;

(2.2.2) calculating all intersection points between the horizontal line and the polygon, and if segment P₀P₂ is horizontal and p·y=p₂·y, adding point P₂ to an intersection point set; and if segment P₀P₂ is horizontal and p₁·y=p₀·y, adding point P₂ to the intersection point set again;

(2.2.3) if segment P₀P₂ is not horizontal, calculating an intersection point IP between line y=p·y and segment P₀P₂, if IP coincides with P₀, determining whether segment P₁P₀ and segment P₀P₂ are on two sides of line y=p·yY, and if yes, adding IP to the intersection point set; or if IP does not coincide with P₀, directly adding IP to the intersection point set;

(2.2.4) sorting points in the intersection point set according to horizontal coordinate values; and

(2.2.5) if a point is on a boundary, determining that the point is not in the polygon; if the number of intersection points is an odd number, determining that the point is outside the polygon; and sequentially taking two points IP₁,IP₂ in the intersection point set, and if p·x>=p₁·x and p·x>=p₂·x determining that point P is in the polygon; otherwise, determining that point P is outside the polygon.

In an embodiment of the present invention, step (3) specifically includes:

(3.1) establishing a thermodynamic model of the distributed underground facility; and

(3.2) simulating the temperature field of the mountain mass containing the distributed underground facility.

In an embodiment of the present invention, step (3.1) specifically includes:

expressing the underground facility and a neighboring cubic area thereof as Ω={x: 0<xᵢ<lᵢ,i=1, 2, 3}, where side lengths of the cubic area along three dimensions x₁, x₂, x₃ are l₁, l₂, l₃, a position of any point in the area is expressed by x=(x₁, x₂, x₃), a target area is Ω₁, a background area is Ω\Ω₁, a target object is a cylinder, an upper surface position is ρ₁, a lower surface position is ρ₂, αₒ and αₛ are respectively thermal diffusion coefficients of the target and the background area, kₒ and kₛ are respectively thermal conductivity coefficients of the target and the background area, observation duration is (0,tₑ), and temperature distribution of any point in the area is recorded as T(x,t), (x,t)εQₜₑ=Ωₓ(0,tₑ);

temperature T(x,t) of any point in area Ω satisfies the following partial differential equations:

$$\begin{matrix}\frac{\partial T ( x , t )}{\partial t} = {α}_{o} {\sum }_{j = 1}^{3} \frac{{\partial }^{2} T ( x , t )}{\partial {x}_{j}^{2}} , ( x , t ) ∈ {Ω}_{1} \times ( 0 , {t}_{e} ) & ( 1 ) \\ \frac{\partial T ( x , t )}{\partial t} = {α}_{s} {\sum }_{j = 1}^{3} \frac{{\partial }^{2} T ( x , t )}{\partial {x}_{j}^{2}} , ( x , t ) ∈ ( Ω \backslash {Ω}_{1} ) \times ( 0 , {t}_{e} ) & ( 2 )\end{matrix}$$

at an interface between the target and the surrounding soil, temperature distribution has continuity, and satisfies the following two constraint conditions:

$$\begin{matrix}{lim}_{y ∈ {Ω}_{1} , y \to x} T ( y , t ) = {lim}_{y ∈ Ω \backslash {Ω}_{1} , y \to x} T ( y , t ) & ( 3 ) \\ {k}_{o} \frac{{\partial T \vert}_{{Ω}_{1}}}{{\partial }_{n}} ( x , t ) = {k}_{s} \frac{{\partial T \vert}_{Ω \backslash {Ω}_{1}}}{{\partial }_{n}} ( x , t ) & ( 4 )\end{matrix}$$

when (x,t)ε(Ω̅∩Ω̅\̅Ω̅₁̅)×(0,tₑ), n is a unit normal vector in space along direction x₁, x₂, or x₃;

where the thermodynamic model of the distributed underground facility satisfies the following initial condition and boundary conditions, including:
initial condition: at an observation start moment, assuming that temperature distribution of underground rock and soil is known, and is recorded as T(x,0),

T(x,0)=g(x),xεΩ (5)

where g(x) is a temperature distribution function, which is obtained by performing interpolation processing on temperature distribution on the surface of rock and soil at the observation start moment and some temperature sample values at different depths;
area surface heat exchange: after the temperature distribution of the area at the observation start moment is known, a change situation thereof needs to be determined; certain boundary conditions are provided, a distribution state of the temperature that changes with space and time inside the area is calculated by using a differential equation of heat conduction, and therefore, temperature distribution on the surface of the target can be obtained, where a boundary condition of surface features is expressed as follows:

$$- {k}_{s} \frac{\partial T}{\partial {x}_{3}} ( x , t ) = {q}_{sun} ( t ) + {q}_{sky} ( t ) + {q}_{conv} ( x , t ) , ( x , t ) ∈ {Γ}_{3}^{1} \times ( 0 , {t}_{e} ) \qquad ( 8 )$$

where qₛᵤₙ and q_{sky} are respectively solar radiation and sky radiation absorbed by soil, q_{conv} is heat absorbed by means of thermal convection between the surface of the area and air, and through mathematical transformation, formula (8) can be expressed in the following linear form:

$$- {α}_{s} \frac{\partial T ( x , t )}{\partial {x}_{3}} ( x , t ) + pT ( x , t ) ∈ {Γ}_{3}^{1} \times ( 0 , {t}_{e} ) \qquad ( 9 )$$

where p and q(t) are respectively a weather condition and a function of soil thermal characteristics, Tₐᵢᵣ is an atmospheric temperature, T₀ is temperature distribution on the surface of soil, and h_{conv} is a thermal convection coefficient between soil and atmosphere;

$$\begin{matrix}p = \frac{{α}_{s}}{{k}_{s}} {h}_{conv} & ( 10 ) \\ q ( t ) = \frac{{α}_{s}}{{k}_{s}} [ {q}_{sun} ( t ) + {q}_{sky} ( t ) + {h}_{conv} {T}_{air} ( t ) ] & ( 11 )\end{matrix}$$

bottom surface condition: assuming that temperature distribution of soil at a position deep enough is constant;

T(x,t)=T_{∞},(x,t)εΓ₃²×(0,tₑ) (12)

where T_{∞} is obtained by performing interpolation processing on measured values at some positions;
vertical boundary condition: assuming that the selected rock and soil area is large enough, temperature distribution of soil on four remaining surfaces after the upper surface and the lower surface of the cubic area are removed satisfies the following boundary condition:

$$\frac{\partial T}{\partial n} ( x , t ) = 0 \qquad ( 13 )$$

where n is an inward or outward unit normal vector on the four remaining surfaces after the upper surface and the lower surface of external surfaces of the rock and soil area Ω are removed; and

a thermal physical model of temperature distribution of an area containing a shallow underground facility is formed according to equations (1) to (4), initial condition (5), and boundary conditions (8), (12), and (13), and by solving the model, surface temperature distribution of an area to be predicted is obtained:

$$\{ \begin{matrix}\frac{\partial T ( x , t )}{\partial t} = {α}_{o} {\sum }_{i = 1}^{3} \frac{{\partial }^{2} T ( x , t )}{\partial {x}_{i}^{2}} , ( x , t ) ∈ {Ω}_{1} \times ( 0 , {t}_{e} ) \\ \frac{\partial T ( x , t )}{\partial t} = {α}_{s} {\sum }_{i = 1}^{3} \frac{{\partial }^{2} T ( x , t )}{\partial {x}_{i}^{2}} , ( x , t ) ∈ ( Ω \backslash {Ω}_{1} ) \times ( 0 , {t}_{e} ) \\ T ( x , 0 ) = g ( x ) , x ∈ Ω \\ - {k}_{s} \frac{\partial T}{\partial {x}_{3}} ( x , t ) = {q}_{sun} ( t ) + {q}_{sky} ( t ) + {q}_{conv} ( x , t ) , ( x , t ) ∈ {Γ}_{3}^{1} \times ( 0 , {t}_{e} ) \\ T ( x , t ) = {T}_{∞} , ( x , t ) ∈ {Γ}_{3}^{2} \times ( 0 , {t}_{e} ) \\ \frac{\partial T}{\partial n} ( x , t ) = 0\end{matrix} .$$

In an embodiment of the present invention, step (3.2) specifically includes: simulating the temperature field, with the effect of the seepage field and without the effect of the seepage field, of the mountain mass containing the distributed underground facility, wherein during a simulation process, the seepage field is equated with multiple “capillary tubes”, each “capillary tube” is a hexahedral cylinder, and the distributed underground facility also consists of multiple cylinder models; and temperatures are granted to corresponding surfaces according to a number of each surface of each tube in the SPTIF integrated with ANSYS, information about the bottom surface, top surface, and side surfaces of the tube, and surface number information of the distributed underground facility, for simulating temperature field distribution of the mountain mass.

In the present invention, a data structure of mountain mass model data is abstracted, and heights of “capillary tubes” randomly and uniformly distributed in the mountain mass are precisely calculated, to construct a seepage field; then information and numbers of the bottom surface, top surface, and side surfaces of the “capillary tubes” and a distributed underground facility are calculated through an automatic detection algorithm and by using information documents of simulation software, and a temperature field of the mountain mass containing the distributed underground facility under the effect of the seepage field is simulated.

### BRIEF DESCRIPTION OF THE DRAWINGS

FIG. 1 is a main interface of an SPTIF platform in an embodiment of the present invention;

FIG. 2 is a plane graph of a geometric structure of an underground cavern in an embodiment of the present invention;

FIG. 3 is a three-dimensional side view of a mountain mass in an embodiment of the present invention;

FIG. 4 is display of contour line data of a mountain mass in ANSYS in an embodiment of the present invention;

FIG. 5 is a geometric model of a distributed underground facility in an embodiment of the present invention;

FIG. 6 is a finite element model of a distributed underground facility in an embodiment of the present invention;

FIG. 7 is a three-dimensional structural diagram of a mountain mass in an embodiment of the present invention;

FIG. 8 is a finite element model of a mountain mass in an embodiment of the present invention;

FIG. 9 is a mountain mass tree structure in an embodiment of the present invention;

FIG. 10 is a schematic view of an algorithm of determining whether a point is in a closed polygon in an embodiment of the present invention;

FIG. 11 is a flow chart of an algorithm of calculating height of a “capillary tube” in an embodiment of the present invention;

FIG. 12 is a sectional view of a mountain mass after “capillary tubes” are added in an embodiment of the present invention;

FIG. 13 is a schematic view of a thermal model of an underground object and soil in an area nearby in an embodiment of the present invention;

FIG. 14 is a flow chart of an algorithm of acquiring information and numbers of surfaces of a “capillary tube” in an embodiment of the present invention;

FIG. 15 shows three-dimensional modeling of an underground facility after a seepage phenomenon is added in an embodiment of the present invention;

FIG. 16 is a simulated top view of a thermal field of a mountain mass without a seepage phenomenon in an embodiment of the present invention;

FIG. 17 is a simulated top view of a thermal field of a mountain mass added with a seepage phenomenon in an embodiment of the present invention;

FIG. 18 is a simulated left sectional view of a thermal field of a mountain mass without a seepage phenomenon in an embodiment of the present invention; and

FIG. 19 is a simulated left sectional view of a thermal field of a mountain mass added with a seepage phenomenon in an embodiment of the present invention.

### DETAILED DESCRIPTION

For clear understanding of the objectives, technical solutions and advantages of the present invention, detailed description of the present invention will be given below in conjunction with accompanying drawings and embodiments. It should be noted that the specific embodiments described herein are only meant to explain the present invention, and not to limit the scope of the present invention. Furthermore, the technical features involved in the embodiments of the present invention as described below could be combined with each other as long as there is no confliction caused.

The present invention uses ANSYS software as a kernel requirement for calculating temperature field distribution of an underground facility, and combines the advanced programming language VC++ and the APDL for secondary development of Simulation Platform Of Temperature/Infrared Image Formation (SPTIF) of the underground target, to establish a physical characteristic model of the distributed underground facility.

The Simulation Platform Of Temperature/Infrared Image Formation (SPTIF) of the underground target is introduced as follows:

The Simulation Platform Of Temperature/Infrared Image Formation of the underground target is a secondary-developed simulation platform for the need of studying an infrared simulation image of an underground facility in this project, where the platform is developed by using ANSYS software as a kernel requirement for calculating temperature field distribution of the underground facility and combining the advanced programming language VC++ and the APDL. The core idea thereof is: calculating a target heat transfer process with the assistance of the ANSYS kernel, generating a corresponding temperature distribution graph, and then calculating, according to an infrared radiation principle of an object, an infrared simulation image thereof. The kernel integrated with the ANSYS software and the VC interface display make the thermal analysis process easier to grasp and use. Moreover, on the basis of the temperature distribution graph, temperature data resolved by ANSYS may be converted into infrared data by means of a developed corresponding temperature-to-infrared algorithm, to obtain an infrared simulation image.

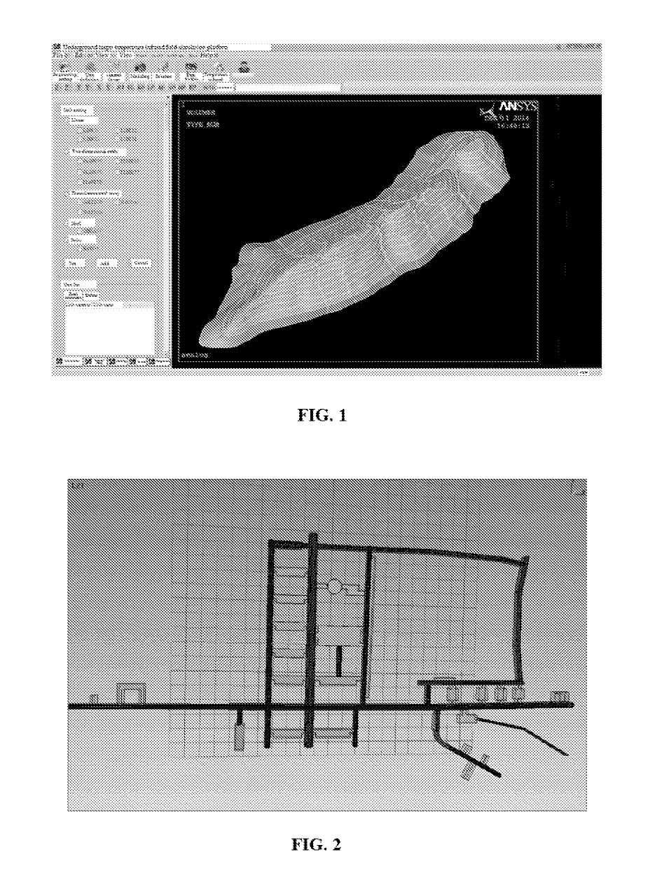

The Simulation Platform Of Temperature/Infrared Image Formation of the underground target is shown in FIG. 1.

According to the double media theory, a seepage field is abstracted to be multiple very thin tubes that are randomly and uniformly distributed in a mountain mass, so as to simulate a temperature field of a distributed underground facility of the mountain mass, thereby reflecting, to the greatest degree, temperature field distribution on the surface of and inside the mountain mass having the distributed underground facility. This is extremely important for guiding detection and identification of an underground facility, and no report the same as the present invention has been found in existing domestic and foreign literatures.

The present invention provides a method for simulating a temperature field of a distributed underground facility of a mountain mass under the influence of a seepage effect, including the following steps:

(1) Perform simulation modeling on physical characteristics and temperature distribution of the mountain mass and the distributed underground facility: perform modeling on physical characteristics of the mountain mass and the distributed underground facility, and directly perform physical characteristic modeling for geometric structures of the mountain mass and the distributed underground facility in an SPTIF according to the physical characteristic models, thereby establishing geometric models of the mountain mass and the distributed underground facility;

(1.1) Perform modeling on physical characteristics of the mountain mass and the distributed underground facility

We conduct theoretical analysis in advance on a relationship between characteristics (including infrared characteristics, multi-spectral/hyperspectral characteristics, electromagnetic wave characteristics, and the like) of the distributed underground facility and the environment, and establish a target physical model for the geometric structure of a typical underground cavern by using MultiGen-Creator, as shown in FIG. 2.

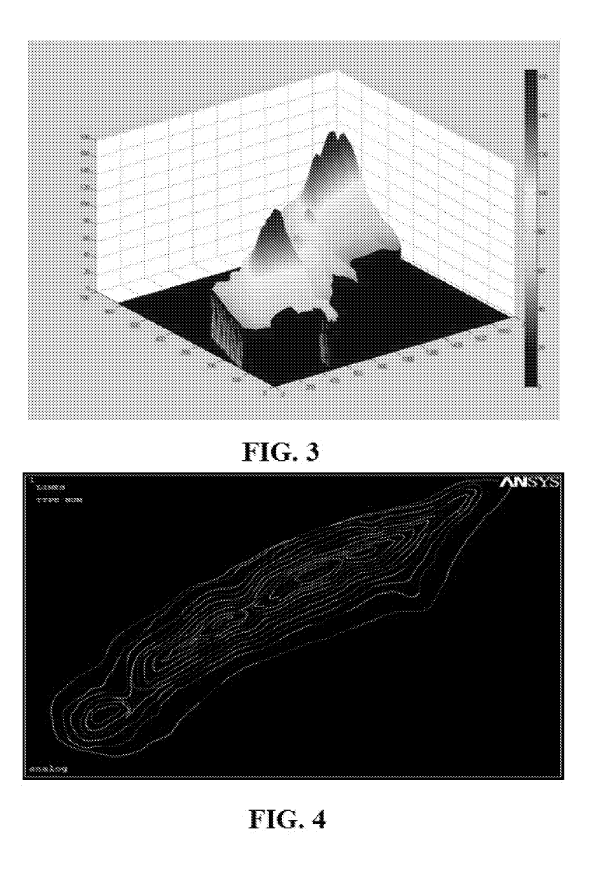

The distributed underground facility is an underground cavern in a mountain mass, and a three-dimensional view of a natural scene of the underground cavern and the mountain mass is drawn by using Matlab software, and a side view thereof is shown in FIG. 3.

The construction of an SPTIF geometric model is based on points, lines, planes, and solids, where points (coordinates) are bases for constructing a geometric model. Geometry is created in the following manner: generating a closed curve using key points, generating a plane using the closed curve, and then forming geometry using a closed curved surface. Therefore, for the three-dimensional view of the mountain mass, we need point coordinates of the surface of the mountain mass. We extract contour lines in Matlab to obtain coordinates of a contour point at a certain height of the mountain mass, and draw a contour line distribution graph in ANSYS, as shown in FIG. 4.

(1.2) Perform simulation modeling on temperature distribution of the mountain mass and the distributed underground facility

Geometric models of the mountain mass and the distributed underground facility are directly established in the SPTIF according to the physical characteristic models, where major tunnels thereof are arch-shaped. The elevation of the mountain mass is approximately 160 meters, and the height of the distributed underground facility is 6 meters.

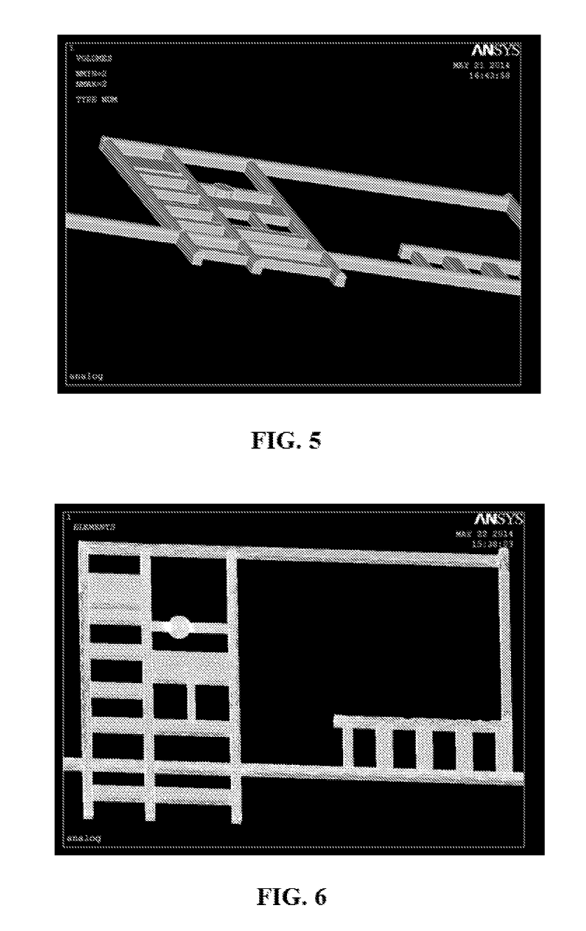

The geometric model of the distributed underground facility is shown in FIG. 5, and after finite element meshing, a three-dimensional model thereof is shown in FIG. 6.

Input contour line data of the mountain mass is saved in 17 different files, where each file includes information about all of a group of points forming a closed curve, and points in the same file are at the same elevation. Therefore, the entire mountain mass is divided into 17 areas according to the contour line data, where these areas are independent of each other and do not intersect with each other in a horizontal direction, and have a hierarchical structure in a vertical direction. A vertical-direction projection of a high-elevation area is included in a low-elevation closed curve, and these data structure features are of great significance for seepage field modeling.

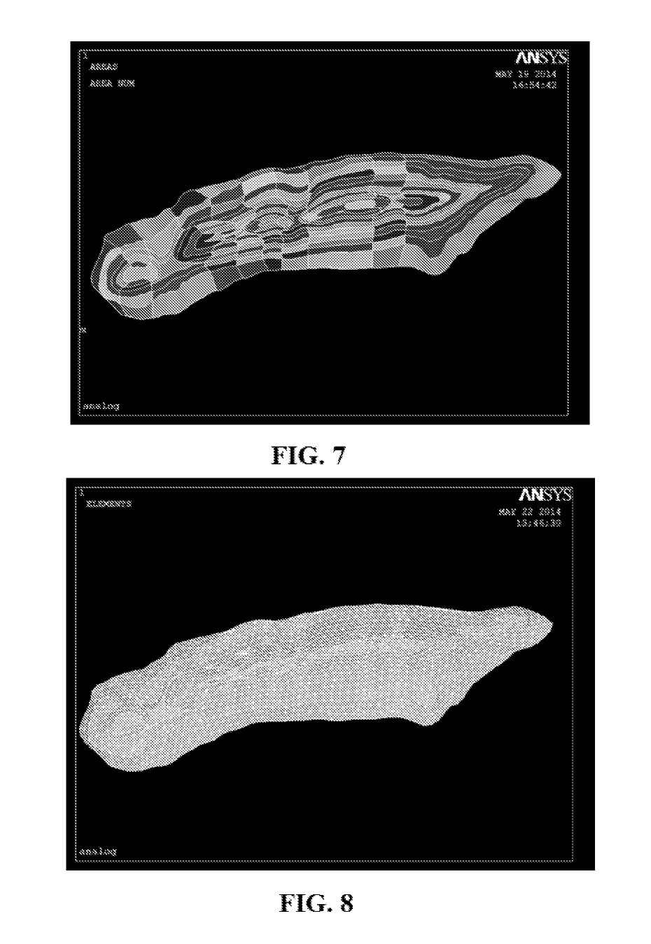

Key points are connected to form curves by using the contour line data, planes are generated by using the closed curves, and a skinning structure is then used on side surfaces to form a closed curved surface for constructing a structural body, thereby implementing simulation realization of complex geometry, where a three-dimensional structural diagram is shown in FIG. 7; then, after finite element meshing, a three-dimensional model is shown in FIG. 8.

(2) Seepage field modeling: Abstract a seepage field to be multiple very thin tubes randomly and uniformly distributed in the mountain mass, and add the tubes to the temperature simulation model of the distributed underground facility.

According to the double media theory, the seepage field is abstracted to be multiple very thin capillary tubes that are randomly and uniformly distributed in the mountain mass, and underground water moves in the capillary tubes. The movement direction is related to multiple factors, and herein we only abstract the seepage field to be capillary tubes in the vertical direction, that is, water moves in the vertical direction. First of all, bottom surface coordinates of a capillary tube are generated randomly, and the height of each capillary tube further needs to be determined, which specifically includes the following steps:

(2.1) Abstract a data structure of mountain mass data, and abstract the entire mountain mass to be a mountain mass tree structure consisting of finite nodes and having a hierarchical relationship.

The contour line data of the mountain mass is divided into 17 areas, where the areas are at the same elevation, and different areas are independent of each other and do not intersect with each other in the horizontal direction, and have a hierarchical structure in the vertical direction, and a vertical-direction projection of a high-elevation area is contained in a low-elevation closed curve. According to a descending order of elevations, we number the areas with the following 17 numbers: 1, 4, 5, 6, (71, 72), (81, 82), 9, 10, (111, 112, 113), (121, 122, 123), and 13. Areas in the same bracket represent that the areas are at the same elevation.

Considering that the mountain mass has a hierarchical structure, different blocks at the same layer are independent of each other, blocks at two neighboring layers have a certain spatial relationship, and the entire mountain mass is a set consisting of finite nodes and having a hierarchical relationship, the mountain mass is further abstracted by using a data structure of a multi-way tree, so as to determine which blocks that the “capillary tubes” spatially belong to, thereby determining height information of the distributed randomly “capillary tubes”. A general idea of constructing a tree structure of the mountain mass is: turning the mountain mass upside down, and using each area as a node, where the bottom of the mountain is a root node of the tree, and if an upper layer and a lower layer have such a closed interval inclusion relationship that a vertical-direction projection of the upper layer contains a vertical-direction projection of the lower layer, the lower layer is a child node of the upper layer. Information of each node is as follows:

```
    Struct Node{
    int NO; //number of the area
    Point *pointArray;  //an array that stores coordinates of all
points forming the closed curve
    Node *childs; // child node of the node
    }
```

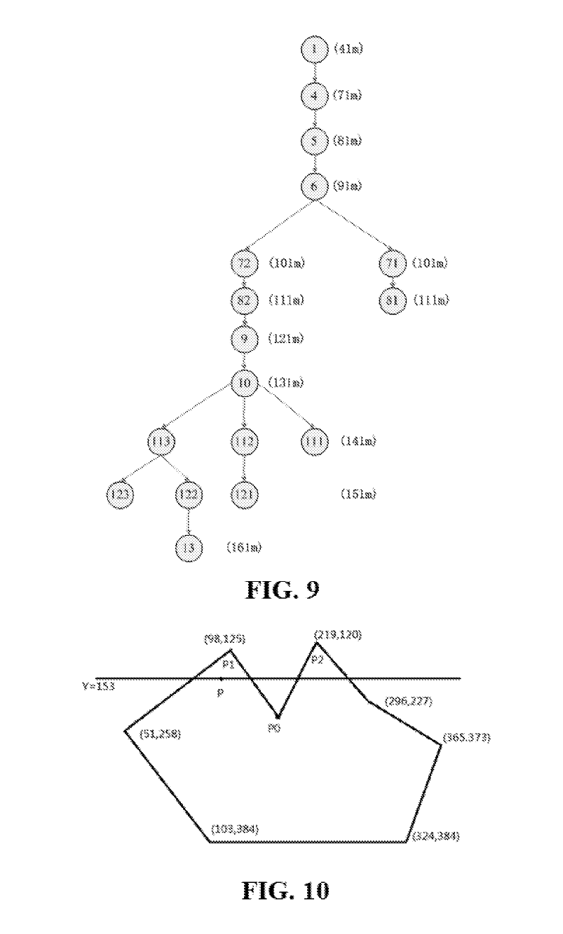

The constructed tree structure of the mountain mass is shown in FIG. 9, where the content in a bracket represents an elevation corresponding to an area at this layer.

(2.2) Traverse the foregoing generated mountain mass tree structure by using an algorithm of determining whether a point is in a closed polygon, generate bottom surface coordinates of multiple random thin tubes, obtain the height of each thin tube, and generate capillary tubes.

To determine the inclusion relationship of vertical-direction projections, there is a need for knowledge of determining whether a point is in a closed graph in computer graphics, and the principle of the algorithm designed in the present invention is as follows:

Herein, a horizontal/vertical intersection point identification method is used (where the method is applicable to any closed polygons, including concave polygon and convex polygon). As shown in FIG. 10, a horizontal line is made from point P, and all intersection points between the line and the polygon are calculated. In the x-axis direction, two intersection points IP₁ and IP₂ are sequentially taken from left to right. If P is in the polygon, point P is inevitably located between point IP₁ and point IP₂ (where if point P coincides with either of point IP₁ and point IP₂, it is also considered that point P is between point IP₁ and point IP₂). Therefore, we can sequentially consider each side of the polygon, to calculate the total number of intersection points.

In the process of calculating the intersection points between the line and the polygon, there are some special cases. This algorithm has the following stipulations, so that whether a point is in a closed polygon can be correctly determined. For point P₀ on the polygon, side P₀P₂ and point P₁ before P₀ are considered:

a. If only P₀P₂ is horizontal, when P is on a line where P₀P₂ is located, add P₂ to an intersection point set.

b. If both segments P₁P₀ and P₀P₂ are horizontal, when P₁ is also on a line where P₀P₂ is located, add P₂ to the intersection point set twice.

c. If an intersection point between line y=p·y and P₀P₂ is P₀, and if P₁P₀ and P₀P₂ are on the same side of y=p·y, add P₀ to the intersection point set twice.

Determine whether point P is in the closed polygon, where p·x and p·y respectively represent the horizontal coordinate and the vertical coordinate of point P, and a specific algorithm process is as follows:

(2.2.1) Make a horizontal line from point P, and traverse, starting from point P₀ of the closed polygon, all points of the entire polygon, where a point before point P₀ is expressed as P₁, and a point after point P₀ is expressed as P₂.

(2.2.2) Calculate all intersection points between the horizontal line and the polygon, and consider special situations, if segment P₀P₂ is horizontal and p·y=p₂·y, add point P₂ to an intersection point set; and if segment P₀P₂ is horizontal and p₁·y=p₀·y, add point P₂ to the intersection point set again.

(2.2.3) If segment P₀P₂ is not horizontal, calculate intersection point IP between line y=p·y and segment P₀P₂, if IP coincides with P₀, determine whether segment P₁P₀ and segment P₀P₂ are on two sides of line y=p·y, and if yes, add IP to the intersection point set; or if IP does not coincide with P₀, directly add IP to the intersection point set.

(2.2.4) Sort points in the intersection point set according to horizontal coordinate values.

(2.2.5) If a point is on a boundary, determine that the point is not in the polygon; if the number of intersection points is an odd number, determine that the point is outside the polygon; and sequentially take two points IP₁,IP₂ in the intersection point set, and if p·x>=p₁·x and p·x>=p₂·x, determine that point P is in the polygon; otherwise, determine that point P is outside the polygon.

(2.3) Generate bottom surface coordinates of multiple randomly distributed thin tubes, obtain the height of each tube, and generate capillary tubes:

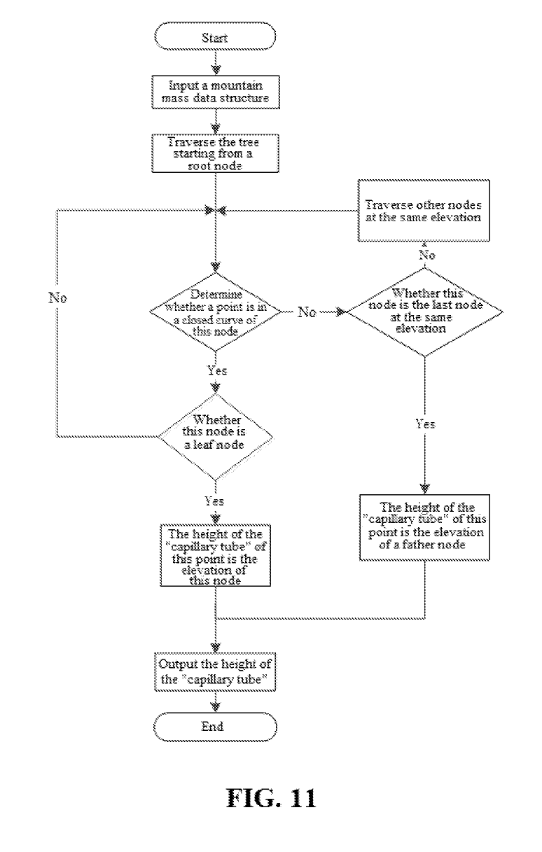

Perform traversing by using the constructed “mountain mass tree” according to an algorithm of determining whether a point is in a closed polygon, where an algorithm process thereof is shown in FIG. 11. We traverse the mountain mass according to this algorithm, to find a highest elevation corresponding to a point, thus determining the height of the “capillary tube”.

When bottom surface coordinates of one “capillary tube” is randomly generated, determine, starting from a node at the bottom layer (node 1 shown in FIG. 9), whether the coordinate points are in a closed curve formed by all points at this layer. If the point is in the closed curve, and if a node where this layer is located is a leaf node, a maximum height of the “capillary tube” is equal to an elevation of this node, or if the node is not a leaf node, child nodes of a lower layer are traversed. If the coordinate points are not in the closed curve, other nodes at the same elevation are traversed. If the coordinate points are not in a closed curve formed by all nodes at this elevation, it indicates that a maximum height of the “capillary tube” is equal to an elevation of a father node of this node. All nodes in the mountain mass tree structure are traversed, to find maximum elevations corresponding to all the nodes, thus determining heights corresponding to all “capillary tubes”.

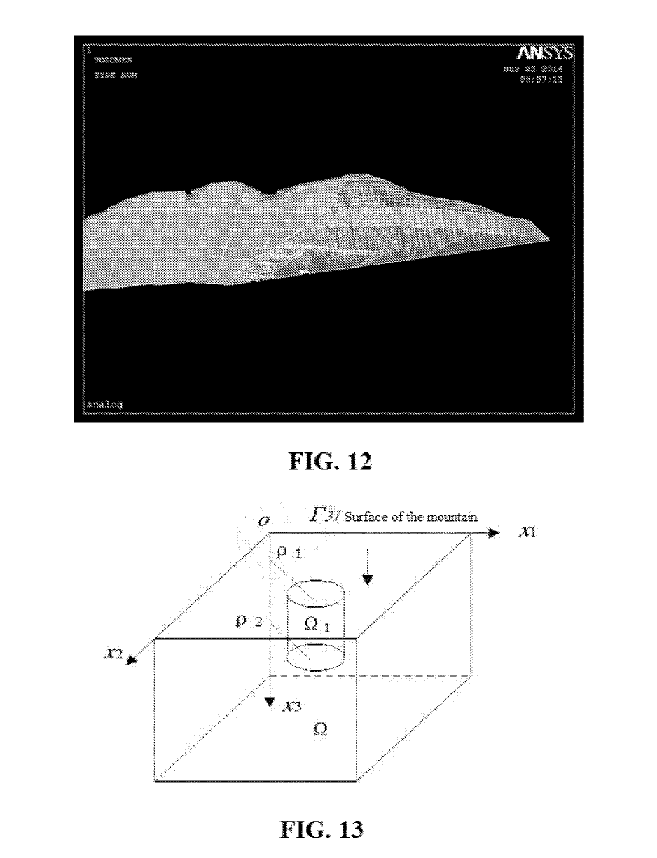

Mount Yujia is simulated by using the SPTIF to obtain a mountain mass, and a sectional view of the mountain mass after “capillary tubes” are added is shown in FIG. 12.

(3) Simulate the temperature field, with the effect of the seepage field and without the effect of the seepage field, of the mountain mass containing the distributed underground facility.

(3.1) Establish a thermodynamic model of the distributed underground facility

To establish the thermal model of the distributed underground facility, we need to make the following assumptions:

1) Medium (rock and soil) of an area in which the target is buried is homogeneous and isotropic.

2) Physical conditions such as moisture content of soil remain unchanged in a period of time.

3) The object is completely buried in the soil and rock.

In theoretical analysis, we use a schematic view of an underground facility and an area nearby for description. As shown in FIG. 13, the entire cubic area is Ω={x:0<xᵢ<lᵢ,i=1, 2, 3}, side lengths of the cubic area along three dimensions x₁, x₂, x₃ are l₁, l₂, l₃, a position of any point in the area is expressed by x=(x₁, x₂, x₃), a target area is Ω₁, a background area is Ω\Ω₁, a target object is a cylinder, an upper surface position is ρ₁, a lower surface position is ρ₂, αₒ and αₛ are respectively thermal diffusion coefficients of the target and the background area, kₒ and kₛ are respectively thermal conductivity coefficients of the target and the background area, observation duration is (0,tₑ), and temperature distribution of any point in the area is recorded as T(x,t), (x,t)εΩₜₑ=Ωₓ(0,tₑ).

Temperature T(x,t) of any point in area Ω satisfies the following partial differential equations:

$$\begin{matrix}\frac{\partial T ( x , t )}{\partial t} = {α}_{o} {\sum }_{j = 1}^{3} \frac{{\partial }^{2} T ( x , t )}{\partial {x}_{j}^{2}} , ( x , t ) ∈ {Ω}_{1} \times ( 0 , {t}_{e} ) & ( 1 ) \\ \frac{\partial T ( x , t )}{\partial t} = {α}_{s} {\sum }_{j = 1}^{3} \frac{{\partial }^{2} T ( x , t )}{\partial {x}_{j}^{2}} , ( x , t ) ∈ ( Ω \backslash {Ω}_{1} ) \times ( 0 , {t}_{e} ) & ( 2 )\end{matrix}$$

at an interface between the target and the surrounding soil, temperature distribution has continuity, and the following two constraint conditions can be obtained:

$$\begin{matrix}{lim}_{y ∈ {Ω}_{1} , y -> x} T ( y , t ) = {lim}_{y ∈ Ω \backslash {Ω}_{1} , y -> x} T ( y , t ) & ( 3 ) \\ {k}_{o} \frac{\partial T {\vert}_{{Ω}_{1}}}{{\partial }_{n}} ( x , t ) = {k}_{s} \frac{\partial T {\vert}_{Ω \backslash {Ω}_{1}}}{{\partial }_{n}} ( x , t ) & ( 4 )\end{matrix}$$

When (x,t)ε(Ω̅∩Ω̅\̅Ω̅₁̅)×(0,tₑ), n is a unit normal vector in space along direction x₁, x₂, or x₃.

To calculate the solution of the set of equations (1) to (4), we further need some initial conditions and boundary conditions. In the following, we will describe how to determine the initial condition and boundary conditions in detail in this model.
Initial condition: Similar to the solution of other dynamic problems, we need to know temperature distribution of an area at an observation start moment. At the observation start moment, we assume that temperature distribution of underground rock and soil is known, and is recorded as T(x,0),

T(x,0)=g(x),xεΩ (5)

g(x) is a temperature distribution function. In an actual problem handling process, the temperature distribution of the underground rock and soil at the observation start moment cannot be directly obtained. We can obtain it by performing interpolation processing on the temperature distribution on the surface of rock and soil at the observation start moment and some temperature sample values at different depths;
Area surface heat exchange: After the temperature distribution of the area at the observation start moment is known, we further need to determine a change situation thereof. A major factor that causes temperature variation of the area is heat exchange between the surface of the area and the external environment, where the heat exchange exists in three forms: thermal radiation, convection, and thermal conduction. Thermal radiation and thermal convection are major forms of the heat exchange between the surface of the area and the external environment, where thermal conduction mainly exists between the surface of the area and the interior of the area. Radiation received by the surface of the area from the external environment mainly comes from the sun and atmosphere in the sky, and meanwhile, the surface of the area also radiates heat to the outside.

a) Solar Radiation (qₛᵤₙ)

Solar radiation energy received by the area mainly includes three parts: direct solar radiation, diffuse solar radiation, and ground return. Direct solar radiation energy received by the surface of the area is associated with the emissivity of the surface of the area, an earth-sun distance, a solar constant, atmospheric quality, atmospheric transparency, and a coefficient of an angle at which the surface of the area receives the direct solar radiation.

b) Sky Atmosphere Radiation (q_{sky})

Radiation of the atmosphere in the sky also influences the temperature variation of the area. The atmospheric radiation is mainly long-wave radiation, and after absorbing heat from the sun and heat from the Earth, the atmosphere has a particular temperature, and therefore, also radiates energy to the outside at every moment.

c) Thermal Convection (g_{conv})

Energy that enters the area by means of convection heat transfer process between the surface of the area and the atmosphere is associated with the temperature of the area, the temperature of the atmosphere, and a convection heat transfer coefficient h (a fluid type, a fluid flowing manner, a fluid state, a solid surface geometric shape, and a temperature difference).

Certain boundary conditions are provided, a distribution state of the temperature that changes with space and time inside the area can be calculated by using a differential equation of heat conduction, and therefore, temperature distribution on the surface of the target can be obtained. The equation of heat conduction is based on the law of conservation of energy and the Fourier law. It is assumed that the density is ρ, the specific heat capacity of surface features is c, t represents time, k represents a heat conductivity coefficient of surface features, and Θᵥ represents heating power.

$$ρ c \frac{\partial T}{\partial t} = \frac{\partial }{\partial x} ( k \frac{\partial T}{\partial x} ) + \frac{\partial }{\partial y} ( k \frac{\partial T}{\partial y} ) + \frac{\partial }{\partial z} ( k \frac{\partial T}{\partial z} ) + {Θ}_{v} \qquad ( 6 )$$

The boundary conditions describe heat exchange between a thermal conductive object and an ambient area where the object is located on the boundary of the object and the ambient environment. It is of great significance for our analysis on an unsteady-state heat conduction process to determine the boundary conditions of the surface features.

$$k \frac{\partial T}{\partial n} {\vert}_{boundary graph} = {q}_{sun} + {q}_{sky} + {q}_{conv} \qquad ( 7 )$$

In the formula, \vec{n} is a normal in an outward direction on a boundary surface between the surface features and the ambient environment.

In the model of the area, the foregoing formula may be expressed in the following form:

$$- {k}_{s} \frac{\partial T}{\partial {x}_{3}} ( x , t ) = {q}_{sun} ( t ) + {q}_{sky} ( t ) + {q}_{conv} ( x , t ) , ( x , t ) ∈ {Γ}_{3}^{1} ( 0 , {t}_{e} ) \qquad ( 8 )$$

where qₛᵤₙ and q_{sky} are respectively solar radiation and sky radiation absorbed by soil, q_{conv} is heat absorbed by means of thermal convection between the surface of the area and air, and through mathematical transformation, formula (8) can be expressed in the following linear form:

$$- {α}_{s} \frac{\partial T ( x , t )}{\partial {x}_{3}} ( x , t ) + pT ( x , t ) ∈ {Γ}_{3}^{1} ( 0 , {t}_{e} ) \qquad ( 9 )$$

where p and q(t) are respectively a weather condition and a function of soil thermal characteristics, Tₐᵢᵣ is atmospheric temperature, T₀ is temperature distribution on the surface of soil, and h_{conv} is a thermal convection coefficient between soil and atmosphere;

$$\begin{matrix}p = \frac{{α}_{s}}{{k}_{s}} {h}_{conv} & ( 10 ) \\ q ( t ) = \frac{{α}_{s}}{{k}_{s}} [ {q}_{sun} ( t ) + {q}_{sky} ( t ) + {h}_{conv} {T}_{air} ( t ) ] & ( 11 )\end{matrix}$$

Bottom surface condition: We assume that temperature distribution of soil at a position deep enough is constant;

T(x,t)=T_{∞},(x,t)εΓ₃²×(0,tₑ) (12)

T_{∞} may be obtained by performing interpolation processing on measured values at some positions. For most rock and soil and weather conditions, generally, rock and soil at a depth of 0.5 m can have a substantially constant soil temperature.
Vertical boundary condition: We assume that the selected rock and soil area is large enough, and temperature distribution of soil on four remaining surfaces after Γ₃¹ and γ₃² of the cubic area are removed satisfies the following boundary condition:

$$\frac{\partial T}{\partial n} ( x , t ) = 0 \qquad ( 13 )$$

n is an inward or outward unit normal vector on the four remaining surfaces after Γ₃¹ and γ₃² of external surfaces of the rock and soil area Ω are removed. This can be construed as that the effect of the underground facility on the temperature distribution of the neighboring area has a limited range.

We establish a thermal physical model of temperature distribution of an area containing a shallow underground facility according to equations (1) to (4), initial condition (5), and boundary conditions (8), (12), and (13), and by solving the model, surface temperature distribution of an area can be accurately predicted:

$$\{ \begin{matrix}\frac{\partial T ( x , t )}{\partial t} = {α}_{o} {\sum }_{i = 1}^{3} \frac{{\partial }^{2} T ( x , t )}{\partial {x}_{i}^{2}} , ( x , t ) ∈ {Ω}_{1} ( 0 , {t}_{e} ) \\ \frac{\partial T ( x , t )}{\partial t} = {α}_{z} {\sum }_{i = 1}^{3} \frac{{\partial }^{2} T ( x , t )}{\partial {x}_{i}^{2}} , ( x , t ) ∈ ( Ω \backslash {Ω}_{1} ) ( 0 , {t}_{e} ) \\ T ( x , 0 ) = g ( x ) , x ∈ Ω \\ - {k}_{s} \frac{\partial T}{\partial {x}_{3}} ( x , t ) = {q}_{sun} ( t ) + {q}_{sky} ( t ) + {q}_{conv} ( x , t ) , ( x , t ) ∈ {Γ}_{3}^{1} ( 0 , {t}_{e} ) \\ T ( x , t ) = {T}_{∞} , ( x , t ) ∈ {Γ}_{3}^{2} ( 0 , {t}_{e} ) \\ \frac{\partial T}{\partial n} ( x , t ) = 0\end{matrix} \qquad ( 13 )$$

(3.2) Simulate the temperature field of the mountain mass containing the distributed underground facility

Simulate the temperature field, with the effect of the seepage field and without the effect of the seepage field, of the mountain mass containing the distributed underground facility, where during a simulation process, the seepage field is equated with multiple “capillary tubes”, each “capillary tube” is a hexahedral cuboid, and the distributed underground facility also consists of multiple cuboidal models. We need to precisely know a number of each surface of each tube in the SPTIF integrated with ANSYS, and information about the bottom surface, top surface, and side surfaces of each tube, and we also need to know surface number information of the distributed underground facility, so as to grant temperatures to corresponding surfaces, and simulate temperature field distribution of the mountain mass. Because there is a tremendous quantity of capillary tubes, the present invention designs a programmed automatic detection method for the information and numbers of the bottom surface, top surface and side surfaces of the cuboid “capillary tubes” and the distributed underground facility. Specific steps are as follows:

1) Perform data processing on point, line, surface, solid information of model of the mountain mass containing the seepage field and the distributed underground facility in the SPTIF.

During temperature distribution simulation modeling for the mountain mass and the distributed underground facility, input contour line data of the mountain mass saves coordinate information of points of closed curves, and key points are connected by using the contour line data to form curves. Planes are formed by using the closed curves, and then a skinning structure is used on side surfaces to form a closed curved surface for constructing a structural body, thereby implementing simulation realization of complex geometry. In a configuration file of the SPTIF integrated with ANSYS, there are point, line, surface, and solid information documents of the model, where the point information document KLIST.txt includes coordinates, numbers, and other information of all points; the line information document LLIST.txt includes line numbers, numbers of two end points, line lengths, and other information; the plane information document ALIST.txt includes plane numbers, and information such as numbers of segments that form a plane; and the solid information document VLIST.txt includes solid numbers, and information such as numbers of planes that form a solid.

We process these information documents, read information and store in a form of a data structure, where the specific data structures are as follows:

A structure of a point is shown in the following table:

| | |
|---|---|
| NO | Number of the point |
| x | Horizontal coordinate of the point |
| y | Vertical coordinate of the point |
| z | Elevation of the point |
| flag | Flag bit, indicating whether the point |
| | is a point of interest |

A structure of a line is shown in the following table:

| | |
|---|---|
| NO | Number of the line |
| point[2] | Structures of two end points of the line |
| flag | Flag bit, indicating whether the line is a line of interest |

A structure of a plane is shown in the following table:

| | |
|---|---|
| NO | Number of the plane |
| line[4] | Structures of four lines forming a closed surface |
| flag | Flag bit, indicating whether the plane is a plane of |
| | interest |
| keypoint | Central point of the plane |
| isbeyondtunnel | Flag bit, indicating whether the plane is a plane |
| | above the underground facility |

Structure information of a solid is shown in the following table:

| | |
|---|---|
| NO | Number of the solid |
| areas[6] | Structures of six surfaces of the solid |
| bottom | Bottom surface of the solid |
| up | Upper surface of the solid |
| sides[4] | Four side surfaces of the solid |
| flag | Flag bit, indicating whether the solid is |
| | a solid of interest |
| height | Height of the solid |

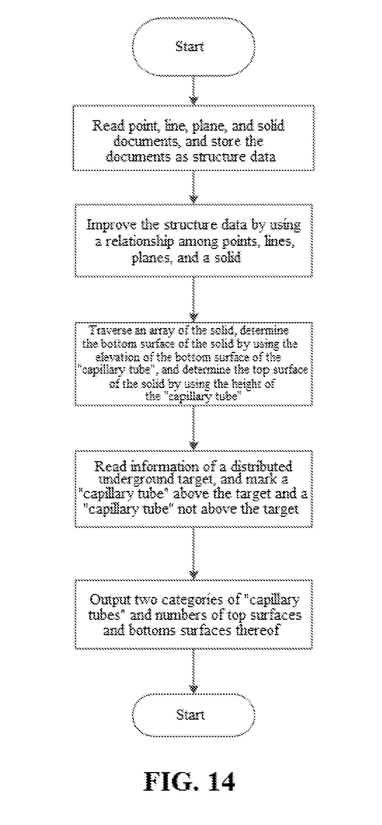

After data structures of the points, lines, planes, and solid are acquired, an algorithm flow chart of specifically detecting numbers and information of the bottom surface, top surface, and side surfaces of the cuboid “capillary tubes” and the distributed underground facility is shown in FIG. 14.

2) Calculate the temperature field distribution by using the information of the surfaces of the “capillary tubes” and the distributed underground facility.

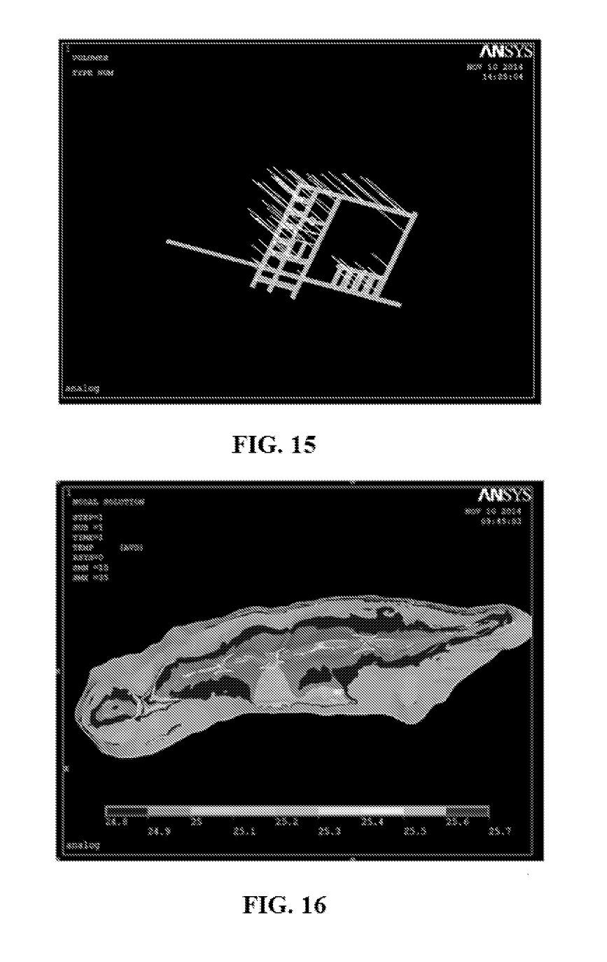

An underground facility three-dimensional model under the effect of a seepage phenomenon is established by using the information of the surfaces of the “capillary tubes” and the distributed underground facility, as shown in FIG. 15.

Boundary conditions are set, and thermal load is loaded. Specific physical property parameters are shown in the following table:

| | | |
|---|---|---|
| Environment temperature | 35° | C. |
| Stratum temperature | 25° | C. |
| Target heat generation rate | 5 × 101 | (W/m³) |
| Medium conductivity coefficient | 3.2 | (W/m° C.) |
| Surface heat transfer coefficient | 2 | (W/m° C.) |

The longitude and latitude of an area where the underground cavern is located is: 30.6 degrees north latitude and 114.1 degrees east longitude, and the elevation is 180 meters. At 9 o'clock in the morning on July 21st, through calculation according to a solar radiation characteristic formula, it is obtained that the direct solar irradiance in the normal direction on the surface of the earth is 82.4 W/m², and the solar irradiance on the due south vertical plane is 11.4 W/m².

By comprehensively considering the roughness degree of the mountain mass surface and an offset angle of the mountain mass relative to the sun, we set that the solar irradiance on a surface exposed to the sun is 10 W/m², and the solar irradiance on a surface in the shade is 8 W/m². That is, thermal flux, converted from solar radiation, on the surface exposed to the sun and on the surface in the shade are 10 W/m² and 8 W/m², respectively. In actual applications, values of the thermal flux are subject to field measurement at the position where the target is located.

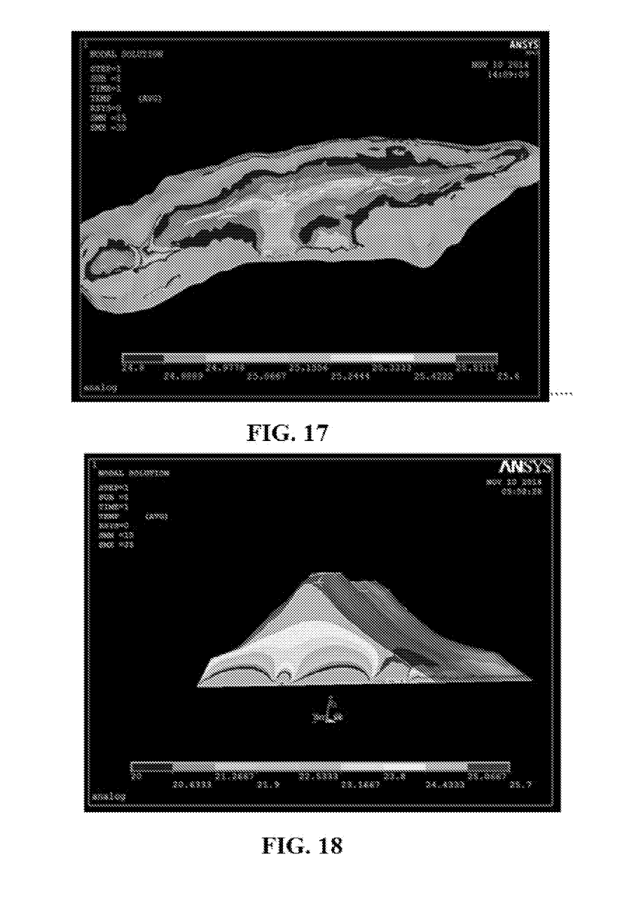

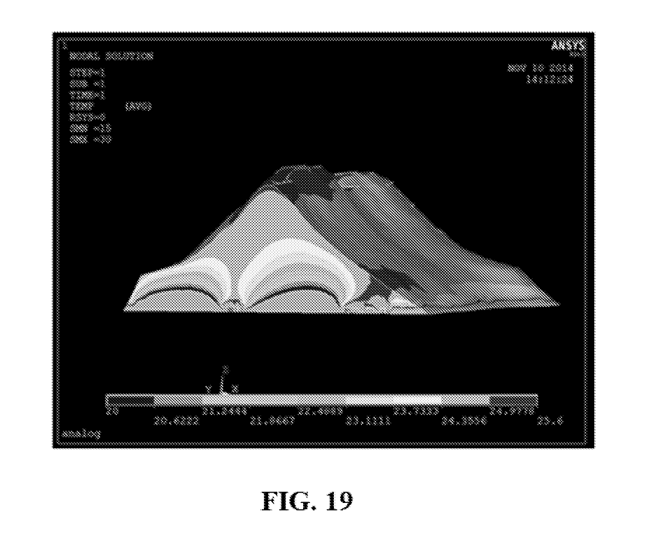

The temperature field distribution, without the effect of the seepage field and with the effect of the seepage field, of the distributed underground facility are respectively simulated, to obtain results shown in the figures below. A simulated top view of mountain mass thermal field without seepage is shown in FIG. 16, and a simulated top view of mountain mass thermal field with seepage is shown in FIG. 17. A simulated left sectional view of mountain mass thermal field without seepage is shown in FIG. 18, and a simulated left sectional view of mountain mass thermal field with seepage is shown in FIG. 19.

The foregoing experiment shows that the seepage makes heat conduction from the underground facility to the surface of the mountain faster and more obvious.

Conclusion of the experiment: it can be seen from the experiment that, the seepage movement of underground water transfers heat by means of thermal convection, and these factors affect the temperature field distribution of the fissured rock mass, and the seepage speed of the underground water in the fissured rock mass directly controls a variation amplitude of temperature of the rock mass. Therefore, seepage has a very obvious effect on temperature.

While preferred embodiments of the present invention have been described above, it will be obvious to those skilled in the art that the present invention is not limited to the preferred embodiments. Any modifications, equivalent replacement, and improvement made without departing from the spirit and principle of the present invention should all fall within the protection scope of the present invention.

1. A method for simulating a temperature field of a distributed underground facility in a mountain mass, wherein the method comprises the following steps:
(1) performing simulation modeling on physical characteristics and temperature distribution of the mountain mass and the distributed underground facility: performing modeling on physical characteristics of the mountain mass and the distributed underground facility, and directly performing physical characteristic modeling for geometric structures of the mountain mass and the distributed underground facility in an SPTIF according to the physical characteristic models, thereby establishing geometric models of the mountain mass and the distributed underground facility;
(2) seepage field modeling: abstracting a seepage field to be multiple thin tubes that are randomly and uniformly distributed in the mountain mass, and adding the tubes to a temperature simulation model of the distributed underground facility; and
(3) simulating the temperature field, with the effect of the seepage field and without the effect of the seepage field, of the mountain mass containing the distributed underground facility.

2. The method of claim 1, wherein step (2) specifically comprises the following sub-steps:
(2.1) abstracting a data structure of mountain mass data, and abstracting the entire mountain mass to be a mountain mass tree structure consisting of finite nodes and having a hierarchical relationship; and
(2.2) traversing the foregoing generated mountain mass tree structure by using an algorithm of determining whether a point is in a closed polygon, generating bottom surface coordinates of multiple random thin tubes, obtaining the height of each thin tube, and generating capillary tubes.

3. The method of claim 2, wherein step (2.1) specifically comprises:
separating contour line data of the mountain mass into 17 areas, wherein the areas are at the same elevation, different areas are independent of each other and do not intersect with each other in a horizontal direction, and have a hierarchical structure in a vertical direction, and a vertical-direction projection of a high-elevation area is contained in a low-elevation closed curve; and
further abstracting the mountain mass by using a data structure of a multi-way tree, wherein a method for constructing the mountain mass tree structure is as follows: turning the mountain mass upside down, and using each area as a node, wherein the bottom of the mountain is a root node of the tree, and if an upper layer and a lower layer have such a closed interval inclusion relationship that a vertical-direction projection of the upper layer contains a vertical-direction projection of the lower layer, the lower layer is a child node of the upper layer.

4. The method of claim 2, wherein step (2.2) specifically comprises:
randomly generating bottom surface coordinates of one “capillary tube”, and determining, starting from a node at the bottom layer of the mountain mass tree structure, whether the coordinate points are in a closed curve formed by all points at this layer, wherein if the coordinate points are in the closed curve, and if a node where this layer is located is a leaf node, a maximum height of the “capillary tube” is equal to an elevation of this node, or if the node is not a leaf node, child nodes of a lower layer are traversed; if the coordinate points are not in the closed curve, other nodes at the same elevation are traversed, and if the coordinate points are not in a closed curve formed by all nodes at this elevation, it indicates that a maximum height of the “capillary tube” is equal to an elevation of a father node of this node; and traversing all nodes in the mountain mass tree structure to find maximum elevations corresponding to all the nodes, thus determining heights corresponding to all “capillary tubes”.

5. The method of claim 4, wherein the algorithm of determining whether a point is in a closed polygon in step (2.2) specifically comprises:
(2.2.1) making a horizontal line from point P, and traversing, starting from point P₀ of the closed polygon, all points of the entire polygon, wherein a point before point P₀ is expressed as P₁, and a point after point P₀ is expressed as P₂;
(2.2.2) calculating all intersection points between the horizontal line and the polygon, and if segment P₀P₂ is horizontal and p·y=p₂·y, adding point P₂ to an intersection point set; and if segment P₀P₂ is horizontal and p₁·y=p₀·y, adding point P₂ to the intersection point set again;
(2.2.3) if segment P₀P₂ is not horizontal, calculating an intersection point IP between line y=p·y and segment P₀P₂, if IP coincides with P₀, determining whether segment P₁P₀ and segment P₀P₂ are on two sides of line y=p·y, and if yes, adding IP to the intersection point set; or if IP does not coincide with P₀, directly adding IP to the intersection point set;
(2.2.4) sorting points in the intersection point set according to horizontal coordinate values; and
(2.2.5) if a point is on a boundary, determining that the point is not in the polygon; if the number of intersection points is an odd number, determining that the point is outside the polygon; and sequentially taking two points IP₁,IP₂ in the intersection point set, and if p·x>=p₁·x and p·x>=p₂·x, determining that point P is in the polygon; otherwise, determining that point P is outside the polygon.

6. The method of claim 2, wherein step (3) specifically comprises:
(3.1) establishing a thermodynamic model of the distributed underground facility; and
(3.2) simulating the temperature field of the mountain mass containing the distributed underground facility.

7. The method of claim 6, wherein step (3.1) specifically comprises:
expressing the underground facility and a neighboring cubic area thereof as Ω={x:0<x₁<lᵢ,i=1, 2, 3}, wherein side lengths of the cubic area along three dimensions x₁, x₂, x₃ are l₁, l₂, l₃, a position of any point in the area is expressed by x=(x₁, x₂, x₃), a target area Ω₁, a background area is Ω\Ω₁, a target object is a cylinder, an upper surface position is ρ₁, a lower surface position is ρ₂, αₒ and αₛ are respectively thermal diffusion coefficients of the target and the background area, kₒ and kₛ are respectively thermal conductivity coefficients of the target and the background area, observation duration is (0,tₑ), and temperature distribution of any point in the area is recorded as T(x,t),(xt)εQₜₑ=Ωₓ(0,tₑ);
temperature T(x,t) of any point in area Ω satisfies the following partial differential equations:
$$\begin{matrix}\frac{\partial T ( x , t )}{\partial t} = {α}_{o} {\sum }_{j = 1}^{3} \frac{{\partial }^{2} T ( x , t )}{\partial {x}_{j}^{2}} , ( x , t ) ∈ {Ω}_{1} ( 0 , {t}_{e} ) & ( 1 ) \\ \frac{\partial T ( x , t )}{\partial t} = {α}_{s} {\sum }_{j = 1}^{3} \frac{{\partial }^{2} T ( x , t )}{\partial {x}_{j}^{2}} , ( x , t ) ∈ ( Ω \backslash {Ω}_{1} ) ( 0 , {t}_{e} ) & ( 2 )\end{matrix}$$
at an interface between the target and the surrounding soil, temperature distribution has continuity, and satisfies the following two constraint conditions:
$$\begin{matrix}{lim}_{y ∈ {Ω}_{1} , y -> x} T ( y , t ) = {lim}_{y ∈ Ω \backslash {Ω}_{1} , y -> x} T ( y , t ) & ( 3 ) \\ {k}_{o} \frac{\partial T {\vert}_{{Ω}_{1}}}{{\partial }_{n}} ( x , t ) = {k}_{s} \frac{\partial T {\vert}_{Ω \backslash {Ω}_{1}}}{{\partial }_{n}} ( x , t ) & ( 4 )\end{matrix}$$
when (x,t)ε(Ω̅∩Ω̅\̅Ω̅₁̅)×(0,tₑ), n is a unit normal vector in space along direction x₁, x₂, or x₃;
wherein the thermodynamic model of the distributed underground facility satisfies the following initial condition and boundary conditions, comprising:
initial condition: at an observation start moment, assuming that temperature distribution of underground rock and soil is known, and is recorded as T(x,0),
T(x,0)=g(x),xεΩ (5)
wherein g(x) is a temperature distribution function, which is obtained by performing interpolation processing on temperature distribution on the surface of rock and soil at the observation start moment and some temperature sample values at different depths;
area surface heat exchange: after the temperature distribution of the area at the observation start moment is known, a change situation thereof needs to be determined; certain boundary conditions are provided, a distribution state of the temperature that changes with space and time inside the area is calculated by using a differential equation of heat conduction, and therefore, temperature distribution on the surface of the target can be obtained, wherein a boundary condition of surface features is expressed as follows:
$$- {k}_{s} \frac{\partial T}{\partial {x}_{3}} ( x , t ) = {q}_{sun} ( t ) + {q}_{sky} ( t ) + {q}_{conv} ( x , t ) , ( x , t ) ∈ {Γ}_{3}^{1} ( 0 , {t}_{e} ) \qquad ( 8 )$$
wherein qₛᵤₙ and q_{sky} are respectively solar radiation and sky radiation absorbed by soil, q_{conv} is heat absorbed by means of thermal convection between the surface of the area and air, and through mathematical transformation, formula (8) can be expressed in the following linear form:
$$- {α}_{s} \frac{\partial T ( x , t )}{\partial {x}_{3}} ( x , t ) + pT ( x , t ) ∈ {Γ}_{3}^{1} ( 0 , {t}_{e} ) \qquad ( 9 )$$
wherein p and q(t) are respectively a weather condition and a function of soil thermal characteristics, Tₐᵢᵣ is an atmospheric temperature, T₀ is temperature distribution on the surface of soil, and h_{conv} is a thermal convection coefficient between soil and atmosphere;
$$\begin{matrix}p = \frac{{α}_{s}}{{k}_{s}} {h}_{conv} & ( 10 ) \\ q ( t ) = \frac{{α}_{s}}{{k}_{s}} [ {q}_{sun} ( t ) + {q}_{sky} ( t ) + {h}_{conv} {T}_{air} ( t ) ] & ( 11 )\end{matrix}$$
bottom surface condition: assuming that temperature distribution of soil at a position deep enough is constant;
T(x,t)T_{∞},(x,t)εγ₃²×(0,tₑ) (12)
wherein T_{∞} is obtained by performing interpolation processing on measured values at some positions;
vertical boundary condition: assuming that the selected rock and soil area is large enough, temperature distribution of soil on four remaining surfaces after the upper surface and the lower surface of the cubic area are removed satisfies the following boundary condition:
$$\frac{\partial T}{\partial n} ( x , t ) = 0 \qquad ( 13 )$$
wherein n is an inward or outward unit normal vector on the four remaining surfaces after the upper surface and the lower surface of external surfaces of the rock and soil area Ω are removed; and
a thermal physical model of temperature distribution of an area containing a shallow underground facility is formed according to equations (1) to (4), initial condition (5), and boundary conditions (8), (12), and (13), and by solving the model, surface temperature distribution of an area to be predicted is obtained:
$$\{ \begin{matrix}\frac{\partial T ( x , t )}{\partial t} = {α}_{o} {\sum }_{i = 1}^{3} \frac{{\partial }^{2} T ( x , t )}{\partial {x}_{i}^{2}} , ( x , t ) ∈ {Ω}_{1} ( 0 , {t}_{e} ) \\ \frac{\partial T ( x , t )}{\partial t} = {α}_{s} {\sum }_{i = 1}^{3} \frac{{\partial }^{2} T ( x , t )}{\partial {x}_{i}^{2}} , ( x , t ) ∈ ( Ω \backslash {Ω}_{1} ) ( 0 , {t}_{e} ) \\ T ( x , 0 ) = g ( x ) , x ∈ Ω \\ - {k}_{s} \frac{\partial T}{\partial {x}_{3}} ( x , t ) = {q}_{sun} ( t ) + {q}_{sky} ( t ) + {q}_{conv} ( x , t ) , ( x , t ) ∈ {Γ}_{3}^{1} ( 0 , {t}_{e} ) \\ T ( x , t ) = {T}_{∞} , ( x , t ) ∈ {Γ}_{3}^{2} ( 0 , {t}_{e} ) \\ \frac{\partial T}{\partial n} ( x , t ) = 0\end{matrix} . \qquad$$

8. The method of claim 7, wherein step (3.2) specifically comprises: simulating the temperature field, with the effect of the seepage field and without the effect of the seepage field, of the mountain mass containing the distributed underground facility, wherein during a simulation process, the seepage field is equated with multiple “capillary tubes”, each “capillary tube” is a hexahedral cylinder, and the distributed underground facility also consists of multiple cylinder models; and temperatures are granted to corresponding surfaces according to a number of each surface of each tube in the SPTIF integrated with ANSYS, information about the bottom surface, top surface, and side surfaces of the tube, and surface number information of the distributed underground facility, for simulating temperature field distribution of the mountain mass.
